(19) United States
(12) Patent Application Publication
(10) Pub. No.: US 2026/0264331 A1
(43) Pub. Date: Sep. 10, 2026

(54) HEATED BED FOR 3D PRINTER AND 3D PRINTER

(71) Applicant: SHENZHEN TUOZHU TECHNOLOGY CO., LTD., Shenzhen (CN)

(72) Inventors: Kaiwang TIAN, Shenzhen (CN); Rongming XIONG, Shenzhen (CN)

(21) Appl. No.: 19/663,309

(22) Filed: Apr. 30, 2026

Related U.S. Application Data
(63) Continuation of application No. PCT/CN2024/124688, filed on Oct. 14, 2024.

(30) Foreign Application Priority Data
Nov. 1, 2023 (CN) 202322959371.X

(51) Int. Cl. B29C 64/295; B29C 64/245; B33Y 30/00

(52) U.S. Cl. CPC B29C 64/295; B29C 64/245; B33Y 30/00

(57) ABSTRACT

The present application discloses a heated bed for a 3D printer and a 3D printer. The heated bed comprises a heated bed body, a heating unit, and a bottom case, wherein one end of the heating unit is configured to be electrically connected to one end of a power supply, and the other end of the heating unit is configured to be electrically connected to the other end of the power supply; the heating unit is disposed between the heated bed body and the bottom case. The heating unit is attached to a surface, proximal to the bottom case, of the heated bed body, and the heating unit is configured to heat the heated bed body. By implementing the present application, the adhesion capability of the print panel can be improved and the print quality can be improved.

### CROSS-REFERENCE S TO RELATED APPLICATIONS

The present application is a continuation application of Internation Patent Application No. PCT/CN2024/124688, filed on October 14, 2024, which claims priority to Chinese Patent Application No. 202322959371X, filed with the China National Intellectual Property Administration on November 01, 2023, and entitled “HEATED BED FOR 3D PRINTER AND 3D PRINTER”, the content of which is incorporated herein by reference in its entirety.

### TECHNICAL FIELD

The present application relates to the field of 3D printing, and in particular, to a heated bed for a 3D printer and a 3D printer.

### BACKGROUND

3D printing technology, also known as additive manufacturing, is a technique for constructing printed objects through layer-by-layer printing using bondable materials based on digital model files.

In the process of 3D printing, when a molten bondable material extruded by a printing head of a 3D printer comes into contact with a print panel, due to the excessively low temperature of the print panel and the influence of thermal expansion and cold contraction, a printed object is prone to edge warping, thereby affecting print quality.

### SUMMARY

Embodiments of the present application provide a heated bed for a 3D printer and a 3D printer.

In a first aspect, the embodiments of the present application provide a heated bed for a 3D printer, and the heated bed includes a heated bed body, a heating unit, and a bottom case. One end of the heating unit is configured to be electrically connected to one end of a power supply, and the other end of the heating unit is configured to be electrically connected to the other end of the power supply; the heating unit is disposed between the heated bed body and the bottom case, where the heating unit is attached to a surface, proximal to the bottom case, of the heated bed body, and the heating unit is configured to heat the heated bed body.

In a second aspect, the embodiments of the present application further provide a 3D printer. The 3D printer includes a base and the heated bed described in the first aspect, where the heated bed is mounted on the base.

In a third aspect, the embodiments of the present application further provide a 3D printer. The 3D printer includes a lead screw and the heated bed described in the first aspect, where the heated bed is mounted on the lead screw.

### BRIEF DESCRIPTION OF THE DRAWINGS

FIG. 1A is a schematic structural diagram of a 3D printer according to an embodiment of the present application;

FIG. 1B is another schematic structural diagram of a 3D printer according to an embodiment of the present application;

FIG. 2 is a schematic structural diagram of a heated bed according to an embodiment of the present application;

FIG. 3 is another schematic structural diagram of a heated bed according to an embodiment of the present application;

FIG. 4 is a schematic structural diagram taken along a line A-A in FIG. 2; and

FIG. 5 is an enlarged schematic diagram of a structure at B in FIG. 4.

### DETAILED DESCRIPTION

Technical solutions in the embodiments of the present application will be clearly and fully described below with reference to the accompanying drawings in the embodiments of the present application.

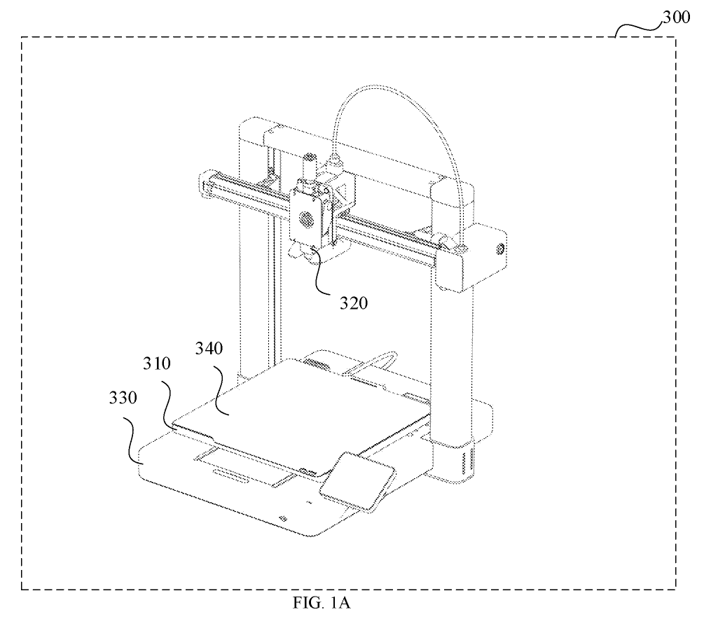

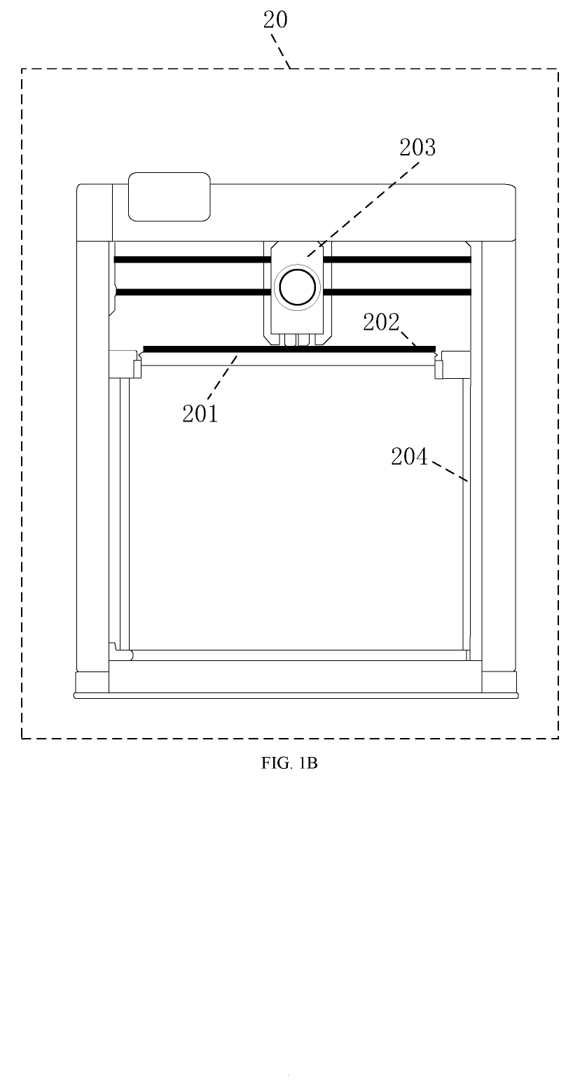

In some feasible embodiments, referring to FIG. 1A, FIG. 1A is a schematic structural diagram of a 3D printer according to an embodiment of the present application. As shown in FIG. 1A, the 3D printer 300 includes: a heated bed 310, a printing head 320, a base 330, and a print panel 340.

The heated bed 310 is disposed on one side, facing the printing head 320, of the base 330, and the heated bed 310 has a heating function. The print panel 340 is disposed on one side, facing the printing head 320, of the heated bed 310, and heat of the heated bed 310 can be conducted to the print panel 340. The heated bed 310 is mounted on the base 330. Illustratively, the base 330 is provided with a guide rail, and the guide rail is slidably connected to the heated bed 310. Specifically, the guide rail is slidably connected to a support in the heated bed 310, such that the heated bed 310 can move back and forth along the guide rail.

A printing material is heated to a molten state in the printing head 320, and the printing head 320 may extrude the printing material in the molten state onto the print panel 340 while moving according to the printing path of the 3D printer 300.

Optionally, in some feasible embodiments, referring to FIG. 1B, FIG. 1B is another schematic structural diagram of a 3D printer according to an embodiment of the present application. As shown in FIG. 1B, the 3D printer 20 includes a heated bed 201, a print panel 202, a printing head 203, and a lead screw 204. Different from the printer shown in FIG. 1A, the heated bed 201 in the printer 20 according to the embodiments of the present application is mounted on the lead screw 204. Specifically, the lead screw 204 is connected to a support in the heated bed 201, and the heated bed 201 can move up and down along the lead screw 204.

FIG. 1A and FIG. 1B show two 3D printers having different structures. The 3D printers having different structures may be provided with a heated bed having the same structure. The heated bed according to the embodiments of the present application is configured to be in contact with a print panel, and the heated bed can be heated, such that the heated bed can transfer heat to the print panel via heat conduction. As a result, the print panel carrying a printed object has a stable temperature, preventing warping of the printed object, thereby improving the adhesion capability of the print panel and improving the print quality of the 3D printer.

Illustratively, the print panel is disposed on one side, facing the printing head, of the heated bed body, and the print panel is configured to carry the printed object.

In some feasible embodiments, the heated bed according to the embodiments of the present application may be further applicable to a 3D printer having another structure, for example, a cantilever structure. That is, the structure type of the 3D printer to which the heated bed is specifically applied is not limited in the embodiments of the present application.

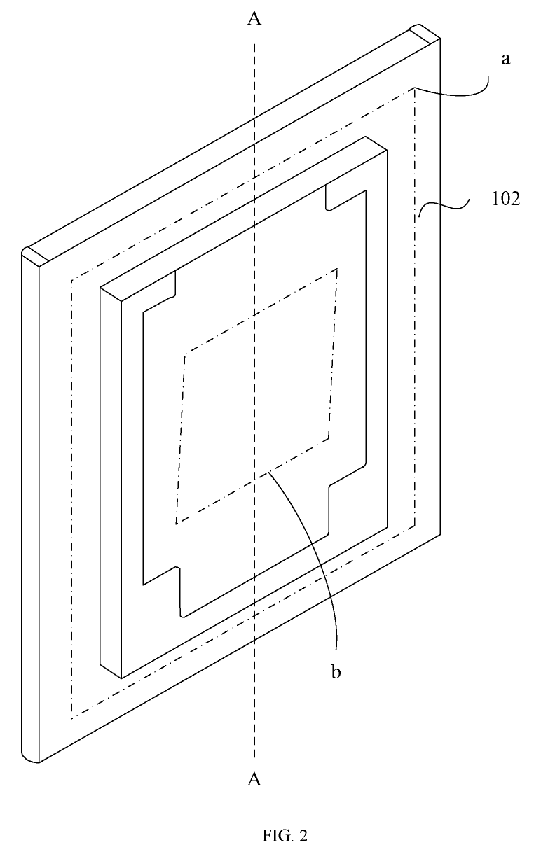

The structure of the heated bed is described in detail below with reference to FIGS. 2 to 5.

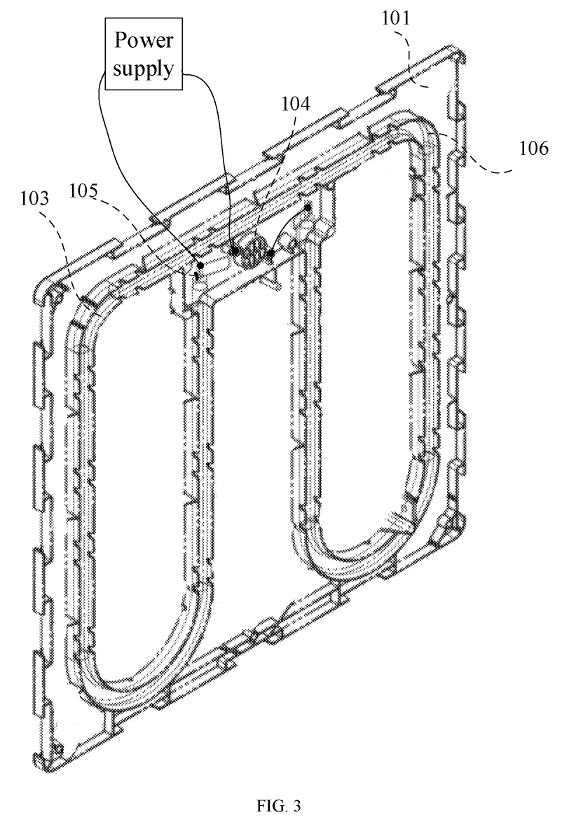

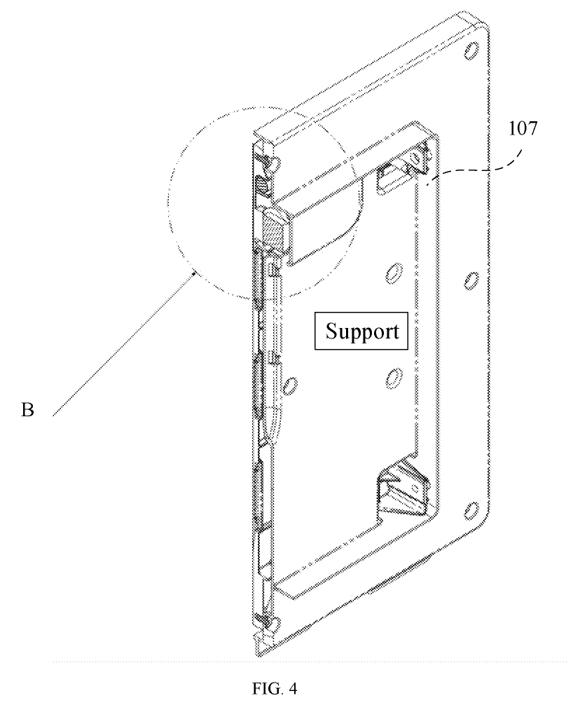

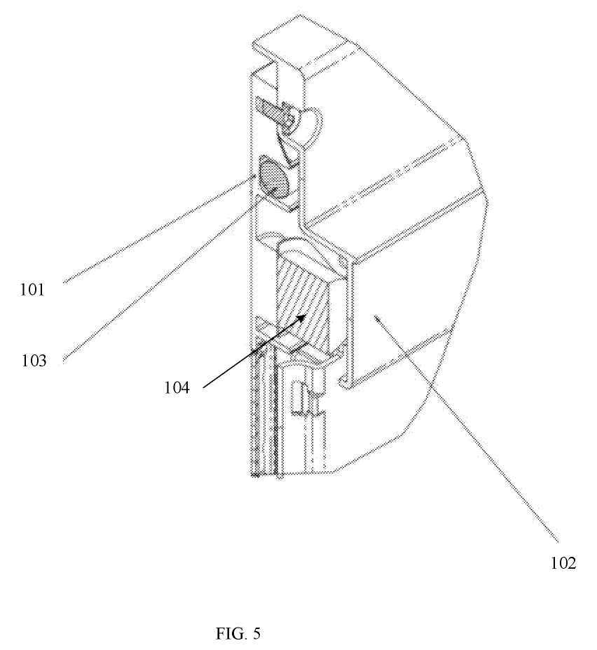

Referring to FIGS. 2 to 5, FIG. 2 is a schematic structural diagram of a heated bed according to an embodiment of the present application, FIG. 3 is another schematic structural diagram of a heated bed according to an embodiment of the present application, FIG. 4 is a schematic structural diagram taken along a line A-A in FIG. 2, and FIG. 5 is an enlarged schematic diagram of a structure at B in FIG. 4.

The heated bed includes a heated bed body 101, and the material of the heated bed body 101 may be metal or plastic. The heated bed body 101 may be a solid plate, or may be a die cast member, a stamped member, an extruded member, or the like.

The heated bed further includes a bottom case 102, and the bottom case 102 is snap-fitted to one side, distal to the printing head, of the heated bed body 101, or the bottom case 102 may be fixedly arranged on one side, distal to the printing head, of the heated bed body 101 by screws.

As shown in FIG. 3, the heated bed further includes a heating unit 103, and the heating unit 103 may be disposed between the heated bed body 101 and the bottom case 102. Moreover, the heating unit 103 may be attached to a surface, proximal to the bottom case, of the heated bed body 101. The heating unit is configured to heat the heated bed body. In this way, the print quality of the 3D printer can be improved.

Illustratively, the heating unit 103 may be fixed by press-fitting, or fixed by screws, or fixed to the first receiving recess 106 through in-mold die casting. A manner in which the heating unit is specifically fixed to the first receiving recess 106 is not limited in the embodiments of the present application.

In some feasible embodiments, the heating unit 103 includes a heating tube and/or a resistance wire. Compared with using an aluminum substrate as the heating source for the heated bed, the embodiments of the present application use a heating tube and/or a resistance wire to heat the heated bed body. The heated bed body in the embodiments of the present application may be a planar part made of one material, which can avoid the problem of poor flatness caused by mixing two materials, aluminum and copper, with different coefficients of expansion in the aluminum substrate. In addition, the aluminum substrate has high cost. Implementing the embodiments of the present application can improve the flatness of the heated bed body while ensuring the heating efficiency and also reduce production costs. As used herein, a heating tube refers generally to a tubular member integrated into the heated bed and configured to perform at least one of: (a) generating thermal energy; and (b) conducting or distributing thermal energy across a surface of the heated bed. The term is not limited to any particular material, heating mechanism, or cross-sectional shape. Non-limiting examples include (i) a resistive heating element disposed at least partly inside a tubular sheath; (ii) a heat pipe; and (iii) a conduit in which heat is transferred at least in part by phase change of a working fluid, among other configurations.

Optionally, a heat-conducting material is applied around the heating tube. The use of the heat-conducting material can increase the contact area between the heating tube and the heated bed body and improve the heating efficiency of the heating tube. Illustratively, the heat-conducting material is applied between the heating tube and the heated bed body. Alternatively, a surface of the heating tube is covered with the heat-conducting material. In some feasible embodiments, the heat-conducting material may be heat-conducting silicone grease.

Optionally, a heat-conducting material is applied around the resistance wire. The use of the heat-conducting material can increase the contact area between the heating tube and the heated bed body and improve the heating efficiency of the heating tube. Illustratively, the heat-conducting material is applied between the resistance wire and the heated bed body. Alternatively, a surface of the resistance wire is covered with the heat-conducting material. In some feasible embodiments, the heat-conducting material may be heat-conducting silicone grease.

In the embodiments of the present application, the heating unit 103 may be configured to heat the heated bed body 101. In a specific implementation, one end of the heating unit 103 may be configured to be connected to one end of a power supply, and the other end of the heating unit 103 is configured to be connected to the other end of the power supply. The power supply provides electric energy for the heating unit 103, and the heating unit 103 heats the heated bed body 101 by converting the electric energy into thermal energy and transferring the thermal energy to the heated bed body 101 via heat conduction.

In the embodiments of the present application, the heated bed is configured to be in contact with the print panel, and the heated bed can be heated, such that the heated bed can transfer heat to the print panel via heat conduction. As a result, the print panel carrying a printed object has a stable temperature, preventing warping of the printed object, thereby improving the adhesion capability of the print panel and improving the print quality of the 3D printer.

Optionally, the heating unit 103 may be symmetrically arranged relative to a center of the heated bed body 101, such that each region of the print panel mounted on the heated bed can be uniformly heated. The heating unit 103 can uniformly heat the heated bed body 101 to ensure uniform heating of the heated bed body, thereby further ensuring that each region of the print panel in contact with the heated bed can be uniformly heated.

In one optional embodiment of the present application, a surface, facing the bottom case, of the heated bed body 101 is provided with a reinforcing rib structure to ensure rigidity of the heated bed body 101.

Optionally, a surface, facing the bottom case, of the heated bed body 101 may be provided with a first receiving recess 106, the first receiving recess 106 being configured to place the heating unit 103. In this way, the relative displacement between the heated bed body 101 and the heating unit 103 is limited, and the stability of the heating unit 103 within the heated bed body 101 is effectively ensured. Illustratively, each recess wall enclosing the first receiving recess 106 and the heated bed body 101 may be integrally formed. By providing the heating unit 103 in the first receiving recess 106, the contact area with the heated bed body 101 can be increased, thereby improving the heating efficiency of the heating unit 103 for the heated bed body 101.

Illustratively, the first receiving recess 106 is symmetrically arranged relative to the center of the heated bed body, which can match the symmetric arrangement of the heating unit 103 relative to the center of the heated bed body 101, thereby better accommodating the heating unit 103.

To make the carrying surface of the heated bed body more uniformly heated, in one optional embodiment of the present application, the first receiving recess 106 may be arranged in a shape resembling the Chinese character "凹" to ensure that the first receiving recess 106 can pass through an edge position of the heated bed body 101 and also a central position of the heated bed body 101.

Alternatively, the first receiving recess 106 may also be "S"-shaped.

In some feasible embodiments, the density of the heating unit 103 arranged along the heated bed body 101 may be increased to reduce the temperature variation across the heated bed body 101. That is, FIGS. 2 to 5 only exemplarily illustrate the arrangement of the heating unit, and in specific practice, the arrangement shape and arrangement density of the heating unit may be changed.

Optionally, as shown in FIG. 4, the above reinforcing rib may also be arranged based on a design position of the first receiving recess 106.

In some feasible embodiments, a surface, facing the bottom case, of the heated bed body 101 may be provided with a switch 104; that is, the switch 104 and the heating unit 103 are located on the same side of the heated bed body 101.

In a specific implementation, the switch 104 and the heating unit 103 are connected in series at two ends of the power supply. The switch 104 is capable of being configured such that: if the temperature of the heated bed body 101 is greater than or equal to a safe temperature, the switch 104 disconnects the electrical connection between the heating unit 103 and the power supply. Illustratively, the safe temperature may be the melting temperature of a printed object material, or the safe use temperature of another hardware. By implementing the embodiments of the present application, the damage to the printed object caused by excessive heat provided by the heating unit 103 can be avoided, or the damage to another hardware of the 3D printer caused by overheating can be avoided, thereby improving the safety of the heated bed during operation and the printing efficiency of the 3D printer.

Optionally, a surface, facing the base of the 3D printer, of the bottom case 102 is provided with a heat insulation layer. For example, the surface, facing the base of the 3D printer, of the bottom case 102 is provided with a plastic member, a heat insulation material, an air thermal barrier, or the like.

Optionally, the heat insulation material may partially cover or entirely cover the bottom of the bottom case. To further improve the heat insulation efficiency of the heat insulation material, in the embodiments of the present application, a cavity may be disposed between the heat insulation material and the bottom case, such that the heat insulation efficiency of the heat insulation material is effectively improved by utilizing the principle of the air thermal barrier.

In some feasible embodiments, the heated bed further includes a temperature sensor 105, the temperature sensor 105 being attached to the surface, proximal to the bottom case, of the heated bed body 101. The temperature sensor 105 is configured to sense the temperature of the heated bed body 101. The temperature sensor 105 is attached to the surface, proximal to the bottom case, of the heated bed body 101 to sense the temperature of the heated bed body 101, thereby improving the efficiency of acquiring the current temperature information of the heated bed.

Illustratively, the temperature sensor 105 is connected to a controller, and sends the sensed temperature of the heated bed body 101 to the controller. In this case, the controller may control on/off of the switch 104 based on a magnitude relationship between the temperature of the heated bed body 101 and the safe temperature.

Optionally, the surface, proximal to the bottom case, of the heated bed body 101 is provided with a fixing recess, and the fixing recess may be configured to fix a connection between the temperature sensor 105 and the heated bed body 101. This limits the relative displacement between the heated bed body 101 and the temperature sensor 105, effectively ensuring the stability of the temperature sensor 105 within the heated bed body 101, and improving the reliability of the temperature sensor 105 in sensing the temperature of the heated bed body 101. As used herein, a fixing recess refers generally to a depression or other recessed feature formed in the heated bed body (including without limitation a groove, a hole, or an indentation), the fixing recess being configured to receive, retain, or secure a component. No particular shape, depth, or size is required.

Illustratively, the temperature sensor 105 is a negative temperature coefficient sensor. In the embodiments of the present application, the negative temperature coefficient sensor NTC may be used as the temperature sensor, to simplify the structural complexity of the heated bed body while ensuring the temperature acquisition efficiency of the temperature sensor.

In some feasible embodiments, the heated bed further includes a support, and the support may be configured to be connected to a base or a lead screw of the 3D printer. Alternatively, the support may be configured to mount the heated bed on the base or the lead screw of the 3D printer.

Optionally, one side, distal to the heated bed body 101, of the bottom case 102 is provided with a second receiving recess 107. In this case, the support in the heated bed may be disposed in the second receiving recess 107, and the support may be configured to mount the heated bed on the base or the lead screw of the 3D printer.

In some feasible embodiments, the heated bed is provided with a magnetic element, and the heated bed is capable of attracting the print panel through the magnetic element. Illustratively, the magnetic element includes a magnet. Specifically, the heated bed may attract the print panel by using one entire magnet having the same surface area as the heated bed, or may attract the print panel by using a plurality of magnets arranged in a distributed manner. The number of the magnetic elements is not specifically limited in the embodiments of the present application.

In some feasible embodiments, the heated bed further includes a first set of magnets and a second set of magnets, and the magnetic force of the first set of magnets is greater than the magnetic force of the second set of magnets. The first set of magnets are disposed in a first region a of the heated bed body, and the second set of magnets are disposed in a second region b of the heated bed body. The second region b is located within the first region a. In the embodiments of the present application, the heated bed body is provided with at least two sets of magnets, such that the print panel is attracted onto the heated bed. The magnetic force of the first set of magnets and the magnetic force of the second set of magnets are different, and the first set of magnets and the second set of magnets are located in different regions of the heated bed body; that is, the second set of magnets with a small magnetic force are located within the first set of magnets with a large magnetic force. In the embodiments of the present application, the arrangement position of the magnets on the heated bed body is optimized. By providing magnets with a relatively large magnetic force in the first region a of the heated bed body and providing magnets with a relatively small magnetic force in the second region b of the heated bed body, the use cost of the magnets can be reduced, thereby reducing the cost of the heated bed.

In some feasible embodiments, a back surface of the heated bed body is provided with a leveling detection device.

In a specific implementation, the leveling detection device may be a leveling detection circuit board, and the leveling detection device may be used to participate in the adjustment of the horizontal flatness of the heated bed.

Meanwhile, since the heated bed body requires a high degree of flatness, in order to avoid making the front surface structure of the heated bed body excessively complex, the leveling detection device may be configured on the back of the heated bed body, thereby ensuring that the heated bed remains horizontal while ensuring a simplified front surface structure of the heated bed body.

Illustratively, the front surface of the heated bed body 101 may be configured with a print panel configured to provide a carrying base. Illustratively, the front surface of the heated bed body may be configured to be in contact with the print panel. Further, the front surface of the heated bed body may be configured to magnetically attract the print panel. Illustratively, the substrate material of the print panel may be high borosilicate glass.

It should be noted that the terms “first” and “second” described above are used for descriptive purposes only and are not to be construed as indicating or implying relative importance.

The above descriptions are specific embodiments of the present application. However, the protection scope of the present application is not limited to this. Any variations or substitutions that those skilled in the art can easily think of within the technical scope disclosed in the present application should be included within the protection scope of the present application. Therefore, the protection scope of the present application should be subject to the protection scope defined by the claims.

What is claimed is:

1. A heated bed for a 3D printer, wherein the heated bed comprises a heated bed body, a heating unit, and a bottom case, wherein
one end of the heating unit is configured to be electrically connected to one end of a power supply, and the other end of the heating unit is configured to be electrically connected to the other end of the power supply;
the heating unit is disposed between the heated bed body and the bottom case, wherein the heating unit is attached to a surface, proximal to the bottom case, of the heated bed body, and the heating unit is configured to heat the heated bed body.

2. The heated bed according to claim 1, wherein the heating unit is symmetrically arranged relative to a center of the heated bed body.

3. The heated bed according to claim 1, wherein a surface, facing the bottom case, of the heated bed body is provided with a first receiving recess, the first receiving recess being configured to place the heating unit.

4. The heated bed according to claim 3, wherein the first receiving recess is symmetrically arranged relative to a center of the heated bed body.

5. The heated bed according to claim 3, wherein the first receiving recess is arranged in a shape resembling the Chinese character "凹" or S-shaped.

6. The heated bed according to claim 1, wherein the heated bed further comprises a switch, the switch being connected in series with the heating unit at two ends of the power supply;
the switch is capable of being configured to: disconnect an electrical connection between the heating unit and the power supply in a case where a temperature of the heated bed body is greater than or equal to a safe temperature.

7. The heated bed according to claim 1, wherein the heated bed further comprises a temperature sensor, the temperature sensor being attached to the surface, proximal to the bottom case, of the heated bed body.

8. The heated bed according to claim 7, wherein the surface, proximal to the bottom case, of the heated bed body is provided with a fixing recess, the fixing recess being configured to fix a connection between the temperature sensor and the heated bed body.

9. The heated bed according to claim 1, wherein the heated bed further comprises a support, the support being configured to mount the heated bed on a base or a lead screw of the 3D printer.

10. The heated bed according to claim 9, wherein one side, distal to the heated bed body, of the bottom case is provided with a second receiving recess, and the support is disposed in the second receiving recess.

11. The heated bed according to claim 1, wherein the heating unit comprises a heating tube and/or a resistance wire.

12. The heated bed according to claim 11, wherein a heat-conducting material is applied around the heating tube, and/or a heat-conducting material is applied around the resistance wire.

13. The heated bed according to claim 1, wherein the heated bed is provided with a magnetic element, and the heated bed is capable of attracting a print panel of the 3D printer through the magnetic element.

14. The heated bed according to claim 1, wherein the heated bed further comprises a first set of magnets and a second set of magnets, and a magnetic force of the first set of magnets is greater than a magnetic force of the second set of magnets,
wherein the first set of magnets are disposed in a first region of the heated bed body, and the second set of magnets are disposed in a second region of the heated bed body; the second region is located within the first region.

15. The heated bed according to claim 1, wherein a surface, facing a base of the 3D printer, of the bottom case is provided with a heat insulation layer.

16. The heated bed according to claim 1, wherein the heated bed further satisfies at least one of the following features:
a surface, facing the bottom case, of the heated bed body is provided with a reinforcing rib structure;
a back surface of the heated bed body is provided with a leveling detection device; and
a front surface of the heated bed body is capable of being configured to be in contact with a print panel of the 3D printer.

17. A 3D printer, wherein the 3D printer comprises a base and a heated bed, the heated bed is mounted on the base, and the heated bed comprises a heated bed body, a heating unit, and a bottom case, wherein
one end of the heating unit is configured to be electrically connected to one end of a power supply, and the other end of the heating unit is configured to be electrically connected to the other end of the power supply;
the heating unit is disposed between the heated bed body and the bottom case, wherein the heating unit is attached to a surface, proximal to the bottom case, of the heated bed body, and the heating unit is configured to heat the heated bed body.

18. The 3D printer according to claim 17, wherein the 3D printer further comprises a print panel and a printing head, the print panel is disposed on one side, facing the printing head, of the heated bed body, and the print panel is configured to carry a printed object.

19. A 3D printer, wherein the 3D printer comprises a lead screw and a heated bed, the heated bed is mounted on the lead screw, and the heated bed comprises a heated bed body, a heating unit, and a bottom case, wherein
one end of the heating unit is configured to be electrically connected to one end of a power supply, and the other end of the heating unit is configured to be electrically connected to the other end of the power supply;
the heating unit is disposed between the heated bed body and the bottom case, wherein the heating unit is attached to a surface, proximal to the bottom case, of the heated bed body, and the heating unit is configured to heat the heated bed body.

20. The 3D printer according to claim 19, wherein the 3D printer further comprises a print panel and a printing head, the print panel is disposed on one side, facing the printing head, of the heated bed body, and the print panel is configured to carry a printed object.
